(19) United States
(12) Patent Application Publication
(10) Pub. No.: US 2023/0271520 A1
(43) Pub. Date: Aug. 31, 2023

(54) MULTI-PART REFUELING DEVICE

(71) Applicant: Tecflower AG, Siebnen (CH)

(72) Inventors: Sascha Reinger, Siebnen (CH); Galina Riegel, Siebnen (CH)

(21) Appl. No.: 17/738,249

(22) Filed: May 6, 2022

(30) Foreign Application Priority Data
Feb. 28, 2022 (CH) CH000203/2022

(51) Int. Cl. B60L 53/35; B67D 7/04; B60L 53/31; B60L 53/16

(52) U.S. Cl. CPC B60L 53/35; B67D 7/0401; B60L 53/31; B60L 53/16; B67D 2007/0474; B67D 2007/0403

(57) ABSTRACT

In a multi-part refueling device for refueling an electric drive battery or a fluid tank of a movable vehicle, simplified, reproducible refueling is to be achieved. The vehicle-side coupling device carried on the vehicle has connecting means designed as at least one charging coil, charging contacts or as a loading nozzle and also has a descending mechanism for lowering the contact plate onto the ground, a displacement mechanism for displacing the contact plate in the ground plane up to a center of the stationary ground coupling device and a lowering mechanism for lowering the connecting means or contact plate as a whole with the connecting means onto the charging coil, the charging contacts or a tank nozzle, wherein the positioning of the contact plate on the stationary ground device is made possible in an automatically controlled manner by a computer and control unit.

### TECHNICAL FIELD

The present invention describes a multi-part refueling device for refueling an electric drive battery or a fluid tank of a movable vehicle, comprising: a vehicle-side coupling device with a charging connection, a computer and control unit, a contact plate connection and a movable contact plate with connecting means; and a ground coupling device arranged stationary and fixed on the ground with at least one charging coil, with charging contacts or a tank nozzle, which are compatible with the selected connecting means. The present invention also describes a refueling method using a multi-part refueling device for refueling an electric drive battery or a fluid tank of a movable vehicle.

### PRIOR ART

Devices and corresponding methods for charging drive batteries of vehicles such as electric vehicles or hybrid vehicles with an electric drive are known in various variants. Above all, the simplicity and user-friendliness are the main characteristics to be developed. At best, the vehicle is simply navigated to a specific position and charged there by manually operating a multi-part refueling device. Usually a user has still to adjust various settings manually. The drive battery is then charged from a power supply network with or without further action on the part of the user.

A multi-part refueling device is known from DE102014221998, which focuses on wireless, inductive charging of the drive battery. An engine-side or vehicle-side coupling device with a charging coil is coupled to a stationary ground coupling device, the charging coil being coupled to a charging coil as part of the ground coupling device, which is supported on the ground. The charging coil or primary coil is usually mounted on the ground of a garage and connected to charging electronics so that an electromagnetic charging field can be generated. As soon as the charging coil or secondary coil is in the electromagnetic charging field of the charging coil, the drive battery can be inductively charged. The movement of the charging coil takes place at ground level. Both coils act as electromagnets, which attract and urge towards each other, depending on the induced current or magnetic field. According to DE102014221998, sufficiently efficient inductive charging should be achievable, corresponding to an optimal alignment of the secondary coil to the primary coil, without a great deal of maneuvering effort.

The position optimization was achieved by moving the primary coil as part of the ground coupling device, by linear displacement, rotation and/or tilting. Positioning signals should be acquired during positioning to achieve adjustment of the primary coil relative to the secondary coil. Based on the positioning signals, adjusting means of the primary coil are necessary in order to optimize the electromagnetic coupling so that, with ever-increasing amounts of energy, lower energy losses and the lowest possible electromagnetic emissions affect the surroundings.

The solution from DE102014221998 requires not only sensors and actuating means but also control electronics for acquiring the sensor data and corresponding feedback positioning of the primary coil on the ground side. This positioning could, of course, also be trained and automated, but this requires an even greater and more complex electronic means and software, which makes the positioning more expensive and also more susceptible to faults. The complex electromechanics must be embedded in the ground and mounted there so that they can be moved.

### PRESENTATION OF THE INVENTION

Here, a simplified, reproducible and secure positioning of a vehicle-side coupling device relative to the ground coupling device has to be provided, which object is achieved by comparatively simple means and enables fully automatic, maintenance-free and less fault-prone refueling of drive batteries but also fluid tanks.

Variations of combinations of features or minor adaptations of the invention can be found in the detailed description, shown in the figures and included in the dependent patent claims.

### BRIEF DESCRIPTION OF THE DRAWINGS

A preferred embodiment of the subject matter of the invention is described below in connection with the accompanying drawings.

In particular

FIG. 1a shows a schematic top view of the multi-part refueling device with a vehicle, the front axle of which has been partially moved onto the stationary ground coupling device, the vehicle-side coupling device still being attached to the underside of the vehicle in the storage state.

FIG. 1b shows a schematic view of the front end of the vehicle from FIG. 1a, a contact plate of the vehicle-side coupling device 2 being lowered onto the ground and moved towards the center of the ground coupling device.

FIG. 2 shows a schematic sectional view of the multi-part refueling device, the contact plate being lowered onto the ground, moved with a displacement mechanism and connecting means of the contact plate being brought into a refueling position on the stationary ground coupling device by means of a lowering mechanism.

### DESCRIPTION

A multi-part refueling device 1 is described herein, which comprises a vehicle-side coupling device 2 and a stationary ground coupling device 3. The vehicle-side coupling device 2 is attached to an underside of a vehicle and can be carried with the vehicle. Only two wheels, the wheel suspension, a drive battery A and a fluid tank B are shown here. The multi-part refueling device 1 is intended to automatically refuel the drive battery A with electricity or the fluid tank B with a fluid, for example a combustion gas.

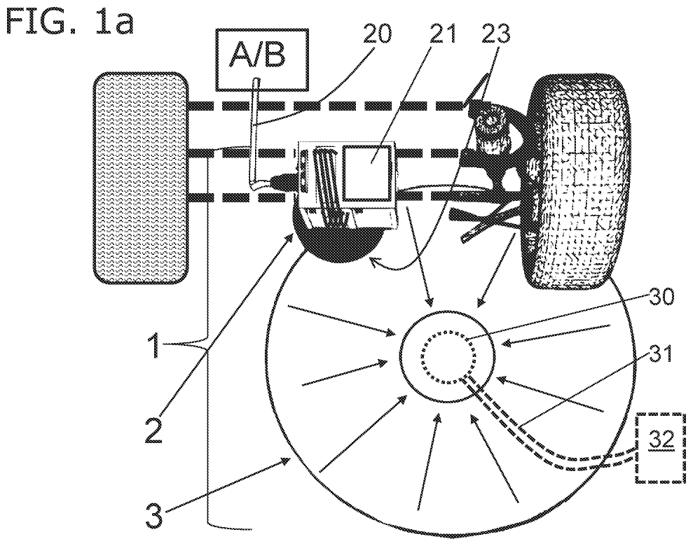

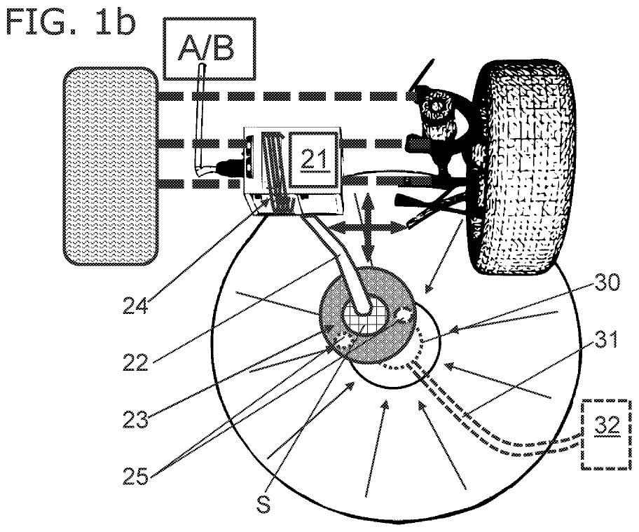

The vehicle-side coupling device 2 is connected via a charging connection 20, which is formed by at least one electric cable, to the drive battery A, or which is formed by a hose, to the fluid tank B, and has a computer and control unit 21 and a contact plate 23 that can be lowered from the vehicle towards the ground. A contact plate connection 22 can be seen in FIG. 1b and can accordingly be formed by at least one electric cable or one fluid hose.

By means of a descending mechanism 24, controlled by the computer and control unit 21, the contact plate 23 can be lowered from the vehicle towards the ground for refueling until it comes into contact with the ground. By means of a displacement mechanism 25 on the contact plate 23, the contact plate 23 is displaced into the center of the stationary ground coupling device 3, in the direction of the arrows, as close as the contact plate connection 22 allows. The transmission of the electric current or the nozzle connection of the fluid hoses is optimal at the center.

After the contact plate 23 has been lowered and moved in the plane by means of the displacement mechanism 25, the contact plate 23 as a whole or a connecting means 230 in the contact plate 23 is lowered flush to the ground by means of a lowering mechanism 26.

A charging coil 30, a charging contact 30 or a tank nozzle 30 is arranged in the center of the ground coupling device 3, is supplied with electricity or a fluid by means of a supply line 31 and can be operated in a controlled manner by means of charging electronics 32 of the stationary ground coupling device 3.

In FIG. 1b, the descending mechanism 24 is shown in the form of a drum with an electric cable or fluid hose 22 that can be wound up and unwound, wherein the contact plate 23 is arranged at the free end of the contact plate connection 22, which contact plate can be lowered from the drum towards the ground under motor control after the vehicle has been parked near the ground coupling device 3. As an alternative to the drum as the descending mechanism 24, an arm to which the contact plate 23 is attached can also be used. The drum and arm are driven electrically, electro-mechanically or pneumatically, under the control of the computer and control unit 21.

A roller construction with at least two movement rollers 25 and a roller motor 25 is provided here as the movement mechanism 25 on the contact plate 23 on the ground after it has been lowered. The displacement mechanism 25 is controlled by the computer and control unit 21. By means of moving rollers 25 and a roller motor 25, the contact plate 23 can be moved parallel to the ground and can be moved in a controllable manner to an optimal refueling area. The displacement mechanism 25 for moving the contact plate 23 parallel to the ground can also be designed as an air cushion mechanism with an air compressor, which enables a sliding movement of the contact plate 23 spaced from the ground.

In order to automate the control, at least one sensor S is arranged on the contact plate 23, in this case in the center of the contact plate 23. Various embodiments of the sensor S are possible, such as an electromagnetic or magnetic sensor, as well as optical sensors in the visible range or in the infrared range or a purely mechanical contact sensor. A corresponding counterpart of the selected sensor S can be attached to the ground coupling device 3 for support. The possible movements of the contact plate 23 in a plane parallel to the ground by the displacement mechanism 25 are indicated by the black double arrow in FIG. 1b.

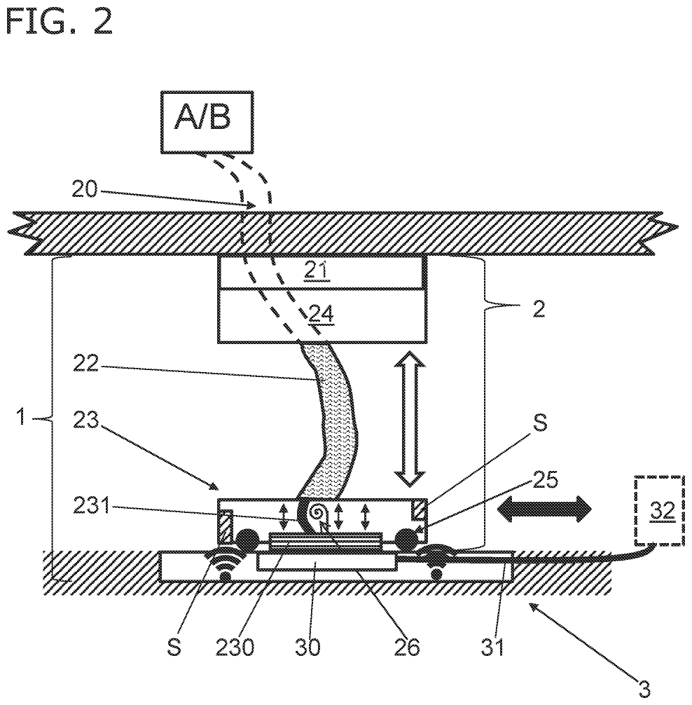

FIG. 2 partially shows a vehicle underbody on which the vehicle-side coupling device 2 is arranged, wherein the computer and control unit 21 allows the contact plate 23 to be lowered by means of the lowering mechanism 24, as indicated by the vertical double arrow.

When the contact plate 23 is lowered on the ground by the descending mechanism 24, the displacement mechanism 25, shown here with the moving roller 25 and roller motor 25, can be moved using the sensors S, to the location with optimum power or fluid transmission, as indicated by the black horizontal double arrow. This allows the contact plate 23 to move in a plane parallel to the ground surface and to the stationary ground coupling device 3.

At the center of the stationary ground coupling device 3, alternating electromagnetic fields, an electric current or the fluid can optimally flow from the charging coil 30, the charging contacts 30 or the tank nozzle 30 into the contact plate 23 or into the connecting means 230 in the form of at least one charging coil 230, two charging contacts 230 or at least one loading nozzle 230, while the refueling process is started. An electric cable 231 or a loading hose 231 leads from the connecting means 230 to the contact plate connection 22 and thus indirectly via the charging connection 20 to the drive battery A or to the fluid tank B.

In order to allow for fully automatic refueling, the optimal position of the contact plate 23 must be found with at least one sensor S through the charging coil 30, the charging contacts 30 or the tank nozzle 30 and the displacement mechanism 25 must be moved thereto.

In order to optimize the contact, either the contact plate 23 as a whole or the charging coil, the charging contacts or the loading nozzle 230 in the contact plate 23 is lowered by means of the lowering mechanism 26.

In FIG. 2, the lowering mechanism 26 is designed as an electric motor, by means of which the connecting means 230 can be lowered towards the ground. The direction of movement of the lowering mechanism 26 is indicated by the vertical double arrows. The lowering mechanism 26 is also controlled by the computer and control unit 21. It is also possible to movably attach the connecting means 230 to a swivel arm, as a result of which the connecting means 230 can be lowered in a controlled manner towards the ground coupling device 3. Alternatively, the lowering mechanism 26 moves the suspension of the moving roller and the rolling motor 25 in a direction of the inner space of the contact plate 23, wherein the connecting means 230 is also lowered.

It is crucial that no movable components are used in the stationary ground coupling device 3 and that the supply line 31 and the charging coil, the charging contacts or the tank nozzle 30 are fixed in a stable manner Refueling can even function without charging electronics 32 if the supply line 31 is always supplied with electricity or fluid.

As soon as the connecting means 230 is connected to the charging coil 30, the charging contacts 30 or the tank nozzle 30, refueling can begin.

Electrical charging of the drive battery A can be achieved by means of wire-bound charging through contact between two charging contacts 230 and charging contacts 30 or by means of wireless charging through contact between a charging coil 230 and a charging coil 30.

If the fluid tank B is to be refueled in the vehicle, a closing contact between the charging port 230 on the contact plate 23 and a tank nozzle 30 on the stationary ground coupling device 3 must be achieved. The contact plate 23 is preferably designed as a multi-layer housing and has an inner space in which the connecting means 230, sensors S, but also the components of the displacement mechanism 25 and/or the components of the descending mechanism 24 can be arranged.

### Refueling Procedure

In order to carry out the refueling method, in a first step, the vehicle must be parked by a vehicle driver in the area of the stationary ground coupling device 3. Here, the vehicle-side coupling device 2 is arranged in the area of the front axle of the vehicle, and the stationary ground coupling device 3 is positioned approximately between the front wheels. Since the ground coupling device 3 is fixed, the vehicle must be positioned accordingly.

Once the vehicle is in place, the computer and control unit 21 can be started and the desired refueling process is started. Accordingly, an operating option for the computer and control unit 21 should be set up on the dashboard of the vehicle. Controlled by the computer and control unit 21, the contact plate 23 is lowered with the descending mechanism 24 from the vehicle until it comes into contact with the ground.

The contact plate 23 is then set in motion by means of the displacement mechanism 25 in the direction of the optimal refueling point of the stationary ground coupling device 3. Controlled by the at least one sensor S, the displacement mechanism 25 finds the best position for the contact plate 23 so that the connecting means 230 are brought at a minimum distance from the charging coil 30, the charging contacts 30 or the tank nozzle 30.

Next, the lowering mechanism 26 is automatically actuated under the control of the computer and control unit 21, as a result of which the connecting means 230 or the contact plate 23 together with the connecting means 230 are coupled to the charging coil 30, the charging contacts 30 or the tank nozzle 30.

If the supply line 31 is constantly supplied with electricity or fluid, the refueling process can begin immediately. The computer and control unit 21 can also be used to monitor the refueling. If the stationary ground coupling device 3 includes the charging electronics 32, then the refueling process can be started accordingly by the charging electronics 32 and ended again after completion. In this case, the charging electronics 32 ensure automatic refueling and termination of the process.

After refueling, the connecting means 230 are released from the stationary ground coupling device 3 again, i.e. removed by means of the lowering mechanism 26, the contact plate 23 is moved away in the plane by means of the displacement mechanism 25 and fastened again to the vehicle floor by means of the descending mechanism 24.

When the charging electronics 32 are used, it can be ensured that the power supply and fluid supply only take place when the refueling process has started, which is preferred for safety and environmental reasons.

### LIST OF REFERENCE NUMERALS

A drive battery (electric vehicle/hybrid vehicle)
B fluid tank
1 multi-part refueling device
2 vehicle-side coupling device
   20 charging connection
   a) electric (from contact plate to drive battery, cable or wireless)
   b) liquid connection (hose to contact plate)
   21 computer and control unit (for positioning and as charge controller)
   22 contact plate connection (fluid hose or electric cable)
   23 contact plate
      230 connecting means=charging coil/charging contact/loading nozzle
      231 electric cable/loading hose
      S sensor (electromagnetic/magnetic/optic (visible spectrum/infrared), contact sensors)
   24 descending mechanism
      drum (with electric cable/fluid hose)
      aim
   25 displacement mechanism on contact plate (in plane)
      moving rollers
      roller motor
   26 lowering mechanism
      electric motor or lowering arm for connecting means
      linear motor for rollers
3 stationary ground coupling device
   30 charging coil/charging contacts/tank nozzle
   31 supply line (electric current/fluid)
   32 charging electronics

1. A multi-part refueling device for refueling an electric drive battery or a fluid tank of a movable vehicle, comprising:
a vehicle-side coupling device with a charging connection, a computer and control unit, a contact plate connection and a movable contact plate with connecting means, and
a ground coupling device arranged in a stationary and fixed manner on the ground with at least one charging coil, with charging contacts or a tank nozzle, which are compatible with the selected connecting means,
wherein
the vehicle-side coupling device carried on the movable vehicle has:
connecting means designed as at least one charging coil, in the form of charging contacts or as loading nozzles,
a descending mechanism for lowering the contact plate to the ground,
a displacement mechanism for displacing the contact plate in the ground plane up to a center of the stationary ground coupling device, and
a lowering mechanism for lowering the connecting means or contact plate as a whole with the connecting means onto the charging coil, the charging contacts or a tank nozzle,
wherein the positioning of the contact plate on the stationary ground device, a refueling process of the electric drive battery or of the fluid tank and the stowing of the contact plate on the underside of the vehicle after the end of the refueling process are automatically controlled by the computer and control unit.

2. The multi-part refueling device of claim 1, wherein the descending mechanism controlled by the computer and control unit is designed as a motor-controlled drum with a contact plate connection formed by an electric cable or a fluid hose, which can be wound up and unwound.

3. The multi-part refueling device of claim 1, wherein the descending mechanism controlled by the computer and control unit is designed as an electrically, electromechanically or pneumatically controlled arm on which the contact plate is arranged so as to be movable toward the ground and back.

4. The multi-part refueling device of claim 1, wherein the displacement mechanism connected to the computer and control unit is formed by at least one moving roller and at least one roller motor and allows an electrically or electromechanically controlled movement in parallel to the ground.

5. The multi-part refueling device of any claim 1, wherein the displacement mechanism connected to the computer and control unit is designed in the form of an air cushion mechanism with an air compressor, which allows a sliding movement of the contact plate spaced from the ground.

6. The multi-part refueling device (1) according to claim 1, wherein the lowering mechanism is connected to the computer and control unit and is in the form of an arm which varies the distance of the contact plate to the ground.

7. The multi-part refueling device of claim 6, wherein the lowering mechanism is connected to the computer and control unit and is designed as an arm which can move a suspension of the at least one movement roller and of the roller motor in the direction of an inner space of the contact plate and back.

8. The multi-part refueling device of claim 6, wherein the lowering mechanism is connected to the computer and control unit and is formed by a swivel arm on which the connecting means is mounted so as to be movable towards the ground coupling device in a controlled manner.

9. The multi-part refueling device of claim 1, wherein at least one sensor is arranged on the contact plate or in the inner space of the contact plate and is connected to the computer and control unit for determining the optimal position relative to the ground coupling device, wherein the at least one sensor is a contact sensor, an electromagnetic sensor, a magnetic sensor, an optical sensor or an infrared sensor.

10. The multi-part refueling device of claim 1, wherein the stationary ground coupling device comprises charging electronics which starts and ends the refueling process, wherein an electric current or a fluid are correspondingly fed in a controlled manner.

11. A refueling method using a multi-part refueling device for refueling an electric drive battery or a fluid tank of a movable vehicle, comprising the steps of:
providing the multi-part refueling device of claim 1,
positioning the vehicle in the vicinity of a locally fixed immovable ground coupling device,
operating a computer and control unit to start the refueling process,
lowering a contact plate in the direction of the ground coupling device on the ground beneath the vehicle by means of a descending mechanism,
moving the contact plate by means of a displacement mechanism parallel to the ground coupling device in such a way that connecting means of the contact plate are brought to a minimum distance from a charging coil, charging contacts or a tank nozzle,
lowering the connecting means or the contact plate together with the connecting means by means of a lowering mechanism under the automatic control of the computer and control unit, and
starting the refueling process by applying electricity to the charging coil or the charging contacts by supplying fluid to the tank nozzle, whereby, after the refueling,
the contact plate is transferred back into a storage state by means of the lowering mechanism, the displacement mechanism and the descending mechanism.

12. The refueling method of claim 11, wherein the descending mechanism is designed as a motor-controlled drum with a contact plate connection formed by an electric cable or a fluid hose, which can be wound up and unwound.

13. The refueling method of claim 11, wherein the descending mechanism is designed as an electrically, electromechanically or pneumatically controlled arm on which the contact plate is arranged so as to be movable toward the ground and back.

14. The refueling method of claim 11, wherein the displacement mechanism connected to the computer and control unit is formed by at least one moving roller and at least one roller motor and allows an electrically or electromechanically controlled movement in parallel to the ground.

15. The refueling method of claim 11, wherein the displacement mechanism connected to the computer and control unit is designed in the form of an air cushion mechanism with an air compressor, which allows a sliding movement of the contact plate spaced from the ground.

16. The refueling method of claim 11, wherein the lowering mechanism is connected to the computer and control unit and is in the form of an arm which varies the distance of the contact plate to the ground.

17. The refueling method of claim 11, wherein the lowering mechanism is connected to the computer and control unit and is designed as an arm which can move a suspension of the at least one movement roller and of the roller motor in the direction of an inner space of the contact plate and back.

18. The refueling method of claim 11, wherein the lowering mechanism is connected to the computer and control unit and is formed by a swivel arm on which the connecting means is mounted so as to be movable towards the ground coupling device in a controlled manner.

19. The refueling method of claim 11, wherein at least one sensor is arranged on the contact plate or in the inner space of the contact plate and is connected to the computer and control unit for determining the optimal position relative to the ground coupling device, wherein the at least one sensor is a contact sensor, an electromagnetic sensor, a magnetic sensor, an optical sensor or an infrared sensor.

20. The refueling method of claim 11, wherein the stationary ground coupling device comprises charging electronics which starts and ends the refueling process, wherein an electric current or a fluid are correspondingly fed in a controlled manner.
